(19) United States
(12) Patent Application Publication
(10) Pub. No.: US 2017/0130404 A1
(43) Pub. Date: May 11, 2017

(54) Synthetic Turf Seaming and System with Adhesive Mesh Inlay components

(71) Applicant: Adhesive Technologies, LLC, Sarasota, FL (US)

(72) Inventors: Margaret D. Kruger, Sarasota, FL (US); Amy R. Luffman, Chatsworth, GA (US); Onelio E. Recinos, Chatsworth, GA (US)

(73) Assignee: Adhesive Technologies, LLC, Sarasota, FL (US)

(21) Appl. No.: 15/338,294

(22) Filed: Oct. 28, 2016

Related U.S. Application Data
(60) Provisional application No. 62/247,676, filed on Oct. 28, 2015.
(60) Provisional application No. 62/262,801, filed on Dec. 3, 2015.

(51) Int. Cl. E01C 13/08; B29C 65/00; B29C 65/52

(52) U.S. Cl. CPC E01C 13/08; B29C 65/522; B29C 66/1142; B29C 66/435; B29K 2075/00

(57) ABSTRACT

Novel application methods and systems for polyurethane adhesives are provided with high pressure application of polyurethane adhesive from mobile dispensing units, and the use of adhesive scrim.

The present application claims priority to U.S. Provisional Patent Application No. 62/247,676 filed Oct. 28, 2015 and U.S. Provisional Patent Application No. 62/262,801 filed Dec. 3, 2015.

### FIELD OF THE INVENTION

Artificial turf is in widespread use on sports playing fields. Many artificial turf fields are laid in strips that are seamed together. Strips of artificial turf may be seamed together in numerous ways including applying adhesives, sewing the edges together, or utilizing various fastener systems. The present invention relates to an improved seaming method, adhesive mesh and system.

### BACKGROUND OF THE INVENTION

Artificial turf surfaces are well known as replacements for natural grass surfaces in stadiums, playgrounds, and many other facilities and applications. The artificial surfaces stand up to wear better than natural grass, require minimal maintenance, and can be used in shaded areas where natural grass is difficult to grow.

Artificial turf is usually manufactured of tufts of extruded polypropylene, polyethylene, or polyamide ribbons that have been placed in a backing sheet comprising one or more layers, and most typically woven polyester. The tufted backing sheet is then typically coated with a secondary backing such as a heat set resin, commonly polyurethane for outdoor installations, for securing the tufts in place in the backing material. Artificial turf is manufactured in strips of about 12 to 15 feet in width and delivered to installation sites in rolls. The artificial turf is often laid over a resilient cushioning layer. Joining roll sections of synthetic turf may require sewing or gluing the edges together. In many cases, the artificial turf is infilled with a granular mixture of rubber and sand or other suitable materials in order to keep the grass ribbons upright and to provide a more natural playing surface.

Artificial turf is manufactured in strips of about 12 to 15 feet in width and delivered to installation sites in rolls. In U.S. Pat. No. 5,958,527, joining roll sections of synthetic turf required sewing or gluing the edges together. U.S. Pat. Nos. 4,581,269 and 7,838,096 disclosed fastening rolled sections of artificial turf using flexible plastic staples or reinforcing fasteners. In U.S. Pat. Nos. 4,822,658, 5,382,462; and 6,083,596, various hooked carpet tapes are utilized and a detailed hook and loop fastening system is described in Publication 2002/0136846. Publication U.S. 2010/0068423 discloses a single component moisture cure polyurethane adhesive. U.S. Publications 2004/0234719 and 2012/0186729 disclose the use of hot melt adhesives for joining strips of artificial turf.

While traditionally sections of artificial turf were sewn together at the seams, sewing has three significant disadvantages. First, sewing is labor intensive and requires experienced installers to implement properly. Secondly, some backing fabrics, especially multi-layer woven and FLW (fiber lock weave) backings, may be so thick or rigid as to be impractical to sew. Finally, thread for sewing a seam effects a mechanical fastening that concentrates stress at fastening points while leaving unbonded spaces between each stitch. This causes the stress between turf sections to be concentrated at stitch locations rather than distributing stress evenly over a large bonding area as can be achieved with gluing.

Artificial turf is often secured in place by laying down the strips of tufted fabric on the resilient cushion or other subsurface that can be sprayed with glue to help stabilize the turf, and a total glue down will generally produce the best installation. Even in a total glue down installation, it is important to seam the sections of artificial turf to prevent edges from working loose over time. When the strips of artificial turf are laid down separately, the seams must be secured and this is typically accomplished by the use of glue in one of several fashions. For instance, substrates may be laid down that underlie the seams of the artificial turf and a layer of glue can be spread across the substrates and then the edges of two adjacent pieces of artificial turf laid down upon the layer of glue. This process is labor intensive and requires workers to spread glue with tools such as trowels. Furthermore, timing issues for both the creation of adequate “green strength” and final cured strength often result in the necessity of allowing seams to cure overnight while weighted to ensure there is no movement of the turf strips.

Green strength or “grab” is a measurement of the adhesive property holding two surfaces together when first contacted while the adhesive is still “green” and before it develops its ultimate bonding properties when fully cured. A high green strength adhesive helps overcome surface movement such as expansion, contraction, wind lift, edge curl, creep, wrinkling, and buoyancy resulting from temperature, humidity, rain, wind, and other weather conditions during installation. It also helps overcome shape memory from stiffness during cold weather installations. Of course, the adhesive should also have strong bonding properties when fully cured and the adhesive should stick to the subsurface for an applicable installation, whether that be asphalt, concrete, wood, shock absorbent underlayments, or strips of seaming tape as well as to the backing of the artificial turf surface being installed.

The use of hot melt adhesives results in a faster final bonding of the seams since there is no cure time. In this case, two strips of artificial turf are laid edge to edge on a support surface over a base tape having a lower surface resting on the support surface or resilient cushion and an upper surface of the base tape will carry a layer of hot melt adhesive. Then preferably a wheeled device is rolled down the seam, lifting the adjacent edges of turf, heating the hot melt adhesive, and then returning the edges of the strips of artificial turf to the hot adhesive where the edges are firmly bonded.

Hot melt adhesive reaches its final bonding strength relatively quickly, however, particularly on sunny days, the hot melt may be relatively slow to establish adequate grab and thus the installation can be slower and more labor intensive than when utilizing a curing adhesive with good green strength. On hot and sunny days, some thermoplastic hot melts may resoften. Finally, because thermoplastic hot melt is applied in a relatively thick form that becomes very hard in cold weather, the seams, numbers, and other inserts bonded with hot melt adhesives may have higher Gmax and hardness underfoot than other parts of the same field.

An alternative method of securing seams is needed that provides relatively rapid bonding times, sufficient softness not to pose injury or playability issues, and operable over a wide range of humidity and temperature conditions. To this end, the present invention is directed to the application of two part polyurethane adhesive on a substrate and the use of a mobile spray rig that promotes deposition of a mixed two part polyurethane adhesive along substrates positioned at seam lines from a hose with spray attachment.

Furthermore, many artificial turf playing surfaces include features that are added for decorative or functional reasons such as numbers, letters, logos, yard lines, and side line or end zone markings. While it is possible to manufacture synthetic turf where the associated features are formed directly as the synthetic fibers are tufted in the manufacturing process, the more typical process for installing these visual features has been accomplished using an inlay process. This process involves cutting various segments of different color artificial turf material for assembly. Assembly is then accomplished by laying the cut pieces face down, using hot melt to preliminarily attach adjacent pieces, and finally securing pieces with the use of a polyurethane coated substrate that is rolled, covered and allowed to cure for up to about twenty-four hours.

As described in more detail below, the process of assembling the inlays is time consuming and requires considerable work space and labor. In addition, once the inlay has been completed and installed on site, the hot melt used for the initial attachment of adjacent pieces has proven to be incompatible with polyurethane adhesives. Specifically, the polyurethane continues to outgas or sublimate over time and causes a reaction that degrades the hot melt. This leaves a gap between adjacent segments of the inlay which can be further weakened both by the increased likelihood of a snag from athlete or other user of the artificial turf surface and by moisture entering the seam between the adjacent inlay segments. The result is that inlays on artificial turf fields may begin to fail after six or seven years rather than the ten to twelve year warranty periods that are typical for such installations. Therefore, it is desirable to produce a new technique for assembling inlays in a more efficient fashion and techniques for ensuring a more lasting joinder between adjacent inlay segments.

### BRIEF DESCRIPTION OF THE DRAWINGS

Embodiments of the invention are described in detail below with reference to the following drawing figures in which the use of like numerals in different figures is intended to illustrate like components.

FIG. 1 is a cross-sectional view at a seam between two strips of artificial turf according to one embodiment;

FIG. 2 is a top plan view of a polyurethane spray system suitable for use in practicing the invention; and

FIG. 3 is a cross-sectional view at a seam between two strips of artificial turf during the application of the polyurethane system to a substrate upon which the strips of artificial turf will be bonded.

FIG. 4 is an illustration of an exemplary system for polyurethane adhesive application;

FIG. 5 is a top plan view of a sports field depicting possible inlay locations;

FIG. 6A through 6C depict prior art inlays on artificial turf fields;

FIG. 7 is a perspective view of a water jet cutting system;

FIG. 8 is a perspective view of a water jet cutting apparatus with artificial turf laid face down, backing side up, on the cutting surface;

FIG. 9 is a perspective view of the artificial turf of FIG. 8 after it has been cut and with segments removed;

FIG. 10 is a work space covered with plastic sheeting;

FIG. 11 is the work space of FIG. 10 with the initial inlay segments positioned on the plastic sheeting;

FIG. 12 is the work surface of FIG. 10 with the majority of the inlay segments positioned;

FIG. 13 is the work surface of FIG. 10 with all the inlay segments positioned and at the beginning of the process of utilizing hot melt to join segments together;

FIG. 14 is a close-up view of the use of a hot melt gun to apply a hot melt bead to join segments together;

FIG. 15 shows an inlay at the completion of the hot melt joining stage of assembly;

FIG. 16 illustrates the inlay of FIG. 15 as polyurethane adhesive coated substrate strips are applied to the seams;

FIG. 17 illustrates the use of a doctor blade to apply polyurethane adhesive to strips of substrate;

FIG. 18A illustrates the application of a polyurethane adhesive coated substrate strip over a hot melt seam;

FIG. 18B illustrates the use of spray dispensed “blue glue” over hot melt seams;

FIG. 19 illustrates the inlay as the application of polyurethane coated strips is nearly complete;

FIG. 20 is a perspective view of the inlay after application of polyurethane coated adhesive strips and as the inlay is being covered with a plastic sheet and being rolled;

FIG. 21 is a perspective view illustrating the placement of plywood boards over the plastic sheeting to weight the inlay as it cures;

FIG. 22 is a perspective view illustrating the inlay after the boards and plastic sheet have been removed and as the inlay is being turned face side up;

FIG. 23 is a perspective view of the face side of the nearly completed inlay;

FIG. 24 is a close-up view of finishing work along the seams of the completed inlay;

FIG. 25A is a sectional view of a prior art inlay seam with hot melt adhesive;

FIG. 25B is a sectional view of a prior art inlay seam with degraded hot melt adhesive;

FIG. 26 is a perspective view of mesh scrim with pressure sensitive adhesive according to embodiments of the present invention;

FIG. 27 is a perspective view of inlay segments with scrim placed to hold the segments in alignment;

FIG. 28 is a sectional view of the joinder of adjacent inlay segments utilizing mesh scrim, pressure sensitive adhesive, and polyurethane; and

FIG. 29 is a logic flow chart of exemplary steps in practicing an aspect of the invention.

### DETAILED DESCRIPTION

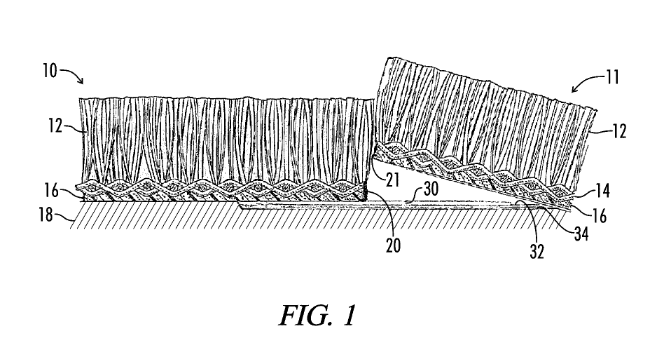

Referring now to the drawings for a better understanding of the invention, FIG. 1 is a cross-sectional view between the seam of two strips of artificial turf, 10, 11. Artificial turf strips 10, 11 each include upstanding filament material 12 resembling or simulating blades of grass extending upwards from a woven backing 14. It will be understood that many artificial surfaces will also include a particulate infill among the upstanding rows of fibers after installation. After the filament material 12 has been tufted in the backing 14, secondary backing 16 is applied. This backing may be a single layer of resin such as urethane or latex, or it may also include a cushion layer. Generally, for an outdoor installation, it is important that the strips of artificial turf be sufficiently porous that appropriate drainage will occur without excessive puddling or accumulation of water that might damage the installation or render the surface unplayable.

The first artificial turf strip 10 has a first edge 20 and the second artificial turf strip 11 has a second edge 21 and the edges 20,21 are to be seamed in close proximity to one another, generally with less than 1/16^{th} of an inch separation. In order to accomplish this seaming, the surface 18 on which the artificial turf is installed, frequently a resilient polymeric material, will have a substrate 32 placed upon it at the approximate location of the seam. The substrate is optionally adhered to the base material 18 by appropriate adhesive layer 34. Adhesive layer 34 may be a contact adhesive and the substrate provided with release tape for ease of installation or other adhesive systems may be used. The substrate 32 provides a consistent surface for the deposit of the seaming adhesive 30. While some base materials might allow for direct application of the seaming adhesive, other base materials that could include dirt, sand, asphalt, and concrete, may benefit from the use of the substrate to support the adhesive.

Upon the substrate 32 is deposited a seaming adhesive, such as a layer of polyurethane material 30 that is preferably a two part curing polyurethane system such as DuraPur® UL-4500 manufactured by IFS Industries. A desirable two component polyurethane adhesive will provide excellent water resistance, hydrolytic stability, and appropriate working times for complex constructions, typically on the order of twenty to sixty minutes. In addition, the polyurethane adhesive should maintain a hardness rating of less than about 70 durometer in order to avoid creating harder spots on the artificial turf surface where seams or numerals are installed, and also to prevent increasing the G-max rating of the field. Preferable two part adhesives have relatively high solids content and viscosity. Viscosity is preferably above about 25,000 cps for both the polyol and isocyanate components and the mixture.

It can be seen that the substrate 32 is wider than the layer of polyurethane material 30 so that it forms a barrier between the polyurethane adhesive and the mounting surface 18. The width of the polyurethane adhesive should be about 1.5 to 4 inches on either side of the center line of the seam so as to provide a well distributed adhesive force. Application of an adhesive layer having overall width of about four to six inches and a thickness of about 10 to 300 mils is generally preferred. The inclusion of moisture in the catalyst or polyol results in some foaming as the polyurethane gels and cures, providing greater flexibility and cushioning in the cured seam, and also expanding to encase and bond with the backing 16 and backstitch fibers on the artificial turf.

In a preferred application, the two part polyurethane adhesive applied to a flexible substrate material such as polyester fabric with a thickness of approximately 0.015 inches will have a Shore A durometer of less than 60, and in any event less than 70 or 90. Typical durometer measurements for hot melt adhesives in cold weather may exceed 90. Durometer hardness is tested according to ASTM designation D 2240-05 “Standard Test Method for Rubber Property—Durometer Hardness.” Other substrates may be suitable since the cured polyurethane provides adequate bonding strength without the requirement of reinforcing fibers from the substrate. Paper, woven fabrics, and nonwoven fabrics may all be used to good advantage.

In addition, the seam may be tested according to the grab test, ASTM D 5034 “Standard Test Method for Breaking Strength and Elongation of Textile Fabrics”. Generally, grab tear strength measured according to ASTM D 5034 for artificial turf must be at least 150 pounds and for some installations minimum requirements may be 200, 250, 300, or even 350 pounds. The two part polyurethane system can achieve grab tear strengths in excess of 400 or 450 pounds although a grab tear strength above 200 pounds is likely be suitable for many applications, and 300 or 350 pounds is readily obtained.

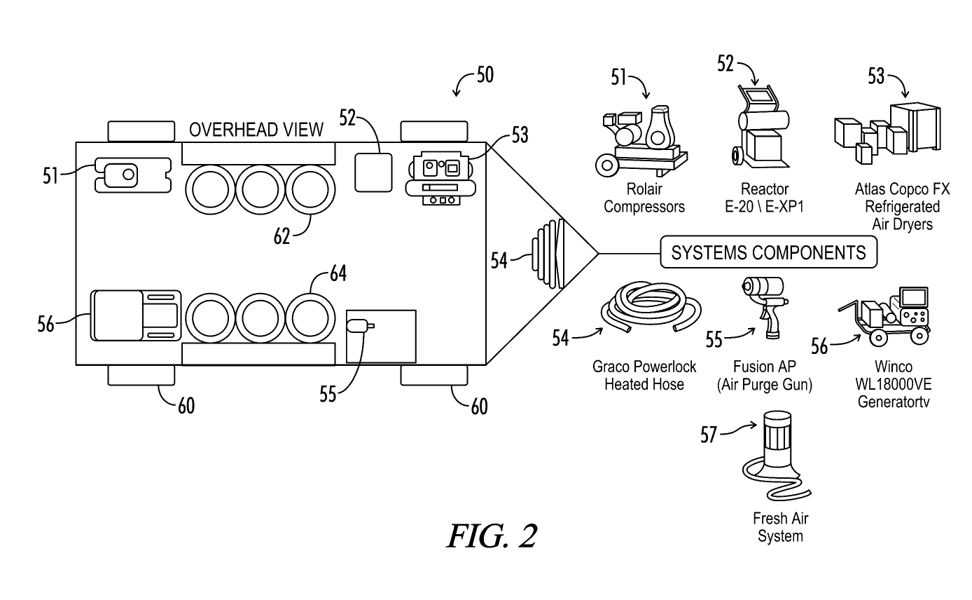

Turning then to FIG. 2, an exemplary polyurethane spray rig 50 is depicted. The exemplary spray rig includes a generator, such as an 18 KwH gasoline or diesel powered generator 56, a refrigerated air dryer 53, an air compressor 51, a fresh air system with full face mask 57 for workers and 200 foot breathing air hose. The polyurethane components may be stored in drums 62 (part A polyol), 64 (part B isocyanate) and mixed in a reactor such as a Graco E20 52 or Graco E30 reactor and dispensed through a 200 foot heated hose 54 or extreme duty hose typically rated over 3000 psi. Preferably the hose and spray gun will be rated for use over 5000 or over 6000 psi to allow for use with high solids and viscosity polyurethane mixtures. For use with the heated hose, a water heater is also provided. A dispensing nozzle such as Graco's XTR7 spray gun 55 is suitable for applying the mixed polyurethane components. The spray gun allows the mixture to be deposited on the substrate at the desired thickness, typically in the range of about 10 up to even 300 mils as needed to bond well with the back side 16 of the artificial turf. The spray rig will also include ancillary items such as plumbing and electrical systems, spray hose rack, fresh air hose rack, filters, outlets, wall heater, tools, gloves, and other customary equipment. Suitable spray rig systems can be obtained from suppliers such as Spray Foam Systems under its ProPAK line of rigs.

The spray rig is mounted on wheels 60 and can be moved along the length of the artificial turf installation and the mixed polyurethane applied to substrate across the 200 foot length of the hoses connecting the reactor to the polyurethane application gun. In this fashion, it is usually possible to lay two or three strips of artificial turf before relocating the spray rig.

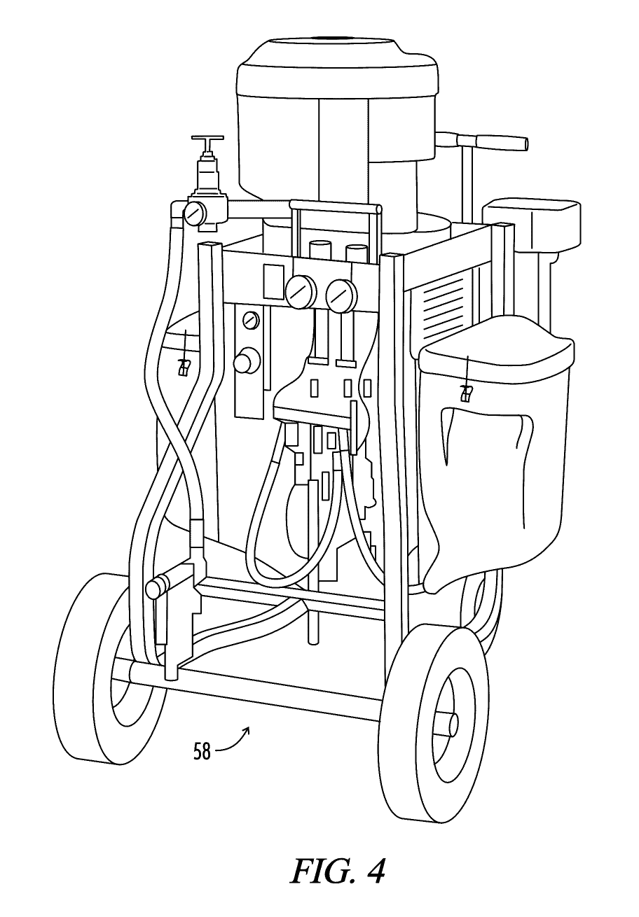

For seaming smaller areas, such as for the insertion of white numerals on a green artificial turf surface, a portable spray rig may be employed, such as the Graco XP70 plural component high pressure sprayer shown in FIG. 4. When a smaller and more easily moved pressure sprayer is used, a shorter hose length is needed so the polyurethane mixture can be deposited with less delay from the mix manifold to the spray head.

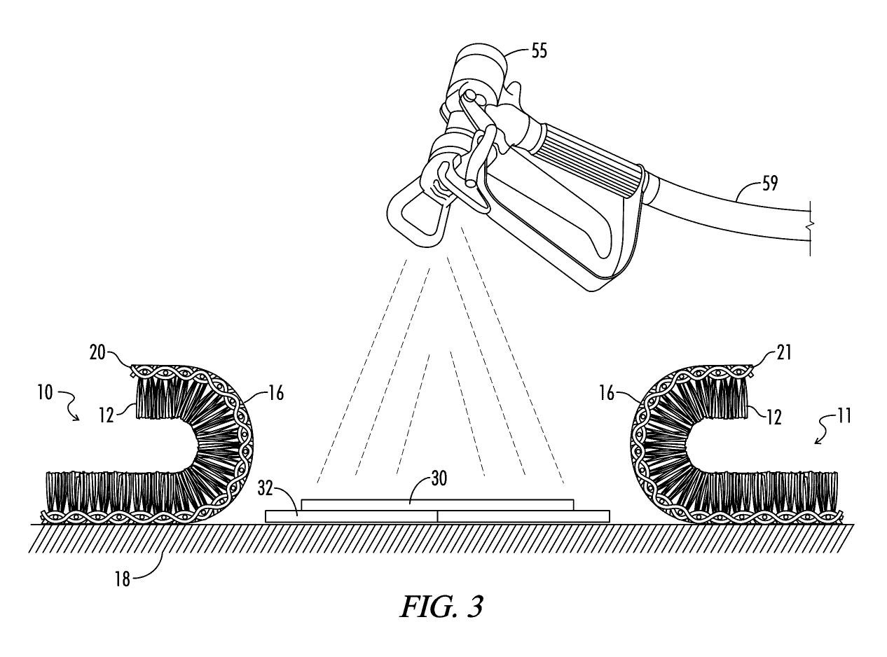

In FIG. 3, the process of applying the mixed polyurethane is illustrated with the two strips of artificial turf, 10, 11 having first been positioned on the base material 18 so that the edges 20,21 to be seamed were in close proximity. The first edge 20 on first artificial turf strip 10 and the second edge 21 of the second artificial turf strip 11 have been rolled back from one another leaving a space on the base material 18. The substrate 32 is then positioned on the base material 18 along the seam location. The substrate 32 provides a consistent surface for the deposit of the seaming adhesive 30 which is preferably delivered by a high pressure spray gun 55 connected by high pressure hose 59, or heated high pressure hose, from the mixing unit or reactor 52. By controlling the temperature of the polyurethane components, and optionally through the use of catalysts, appropriate working times for complex constructions, typically on the order of twenty to sixty minutes can be obtained in a wide range of temperature and humidity conditions.

It can be seen that the substrate 32 is wider than the layer of polyurethane material 30 so that it forms a barrier between the polyurethane adhesive and the mounting surface. The width of the polyurethane adhesive should be about three to eight inches so as to provide a well distributed adhesive force. After the adhesive 30 has been delivered, the rolled edges 20, 21 are again laid flat over the adhesive 30 and substrate 32 and the seam may be rolled with weight to fully enmesh the backing 16 of the artificial turf strips 10, 11 in the adhesive 30 before it cures.

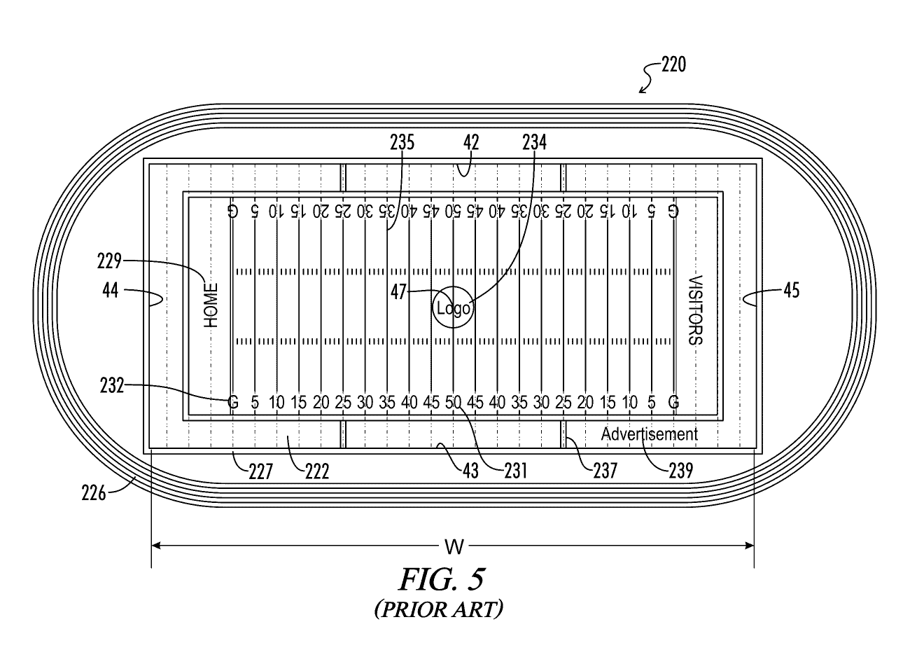

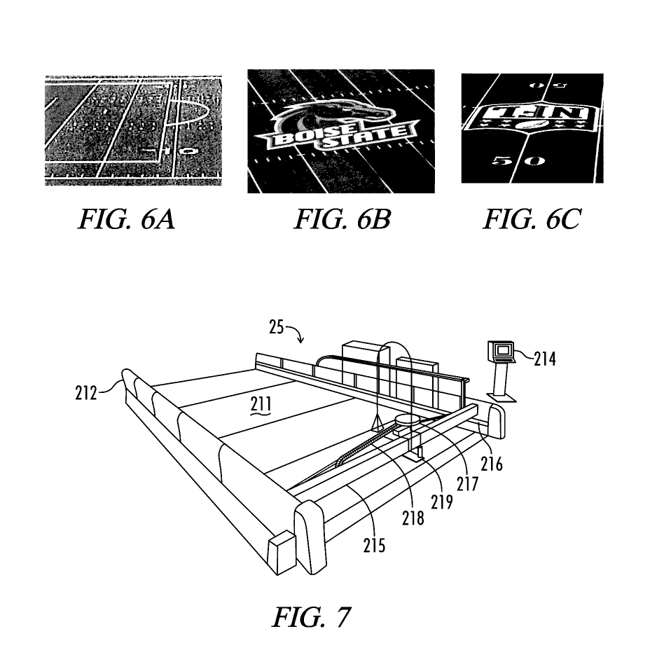

FIG. 5 illustrates a top view of a sports playing surface 220 in the form of a football field. The surface is fabricated from a plurality of strips 222 of artificial turf placed lengthwise from one side 42 to the opposite side 43, shown as being laid top to bottom in FIG. 5. The overall length (W) of the field 220 extending from a left end 44 to a right end 45. In addition, a track 226 may be installed around the playing surface 220. The playing surface 220 may have a series of numbers 231, letters 232, logos 234, yard lines 235, side line markings 37, or other markings 239 including end zone markings 229 preferably inlaid within the surface of one or more strips 222 of the artificial turf. An existing process of manufacturing these inlays is described further below in connection with FIGS. 7-24. As shown in FIGS. 6A through 6C, inlays may be used for functional purposes such as soccer and American football field markings in FIG. 6A or midfield logos in FIGS. 6B and 6C.

The water jet cutting device 25 of FIG. 7 has a cutting bed 211 positioned between side rails 212 and operated from controller 214. The water jet cutting system 25 utilizes belt drives 216,218 to move the water jet 219 over the bed 211 as desired. The belt drive 216 moves the cross bar 215 in the direction of the X-axis from left to right while the belt drive 218 on the cross arm 215 moves the water jet head 219 up and down in the direction of the Y-axis.

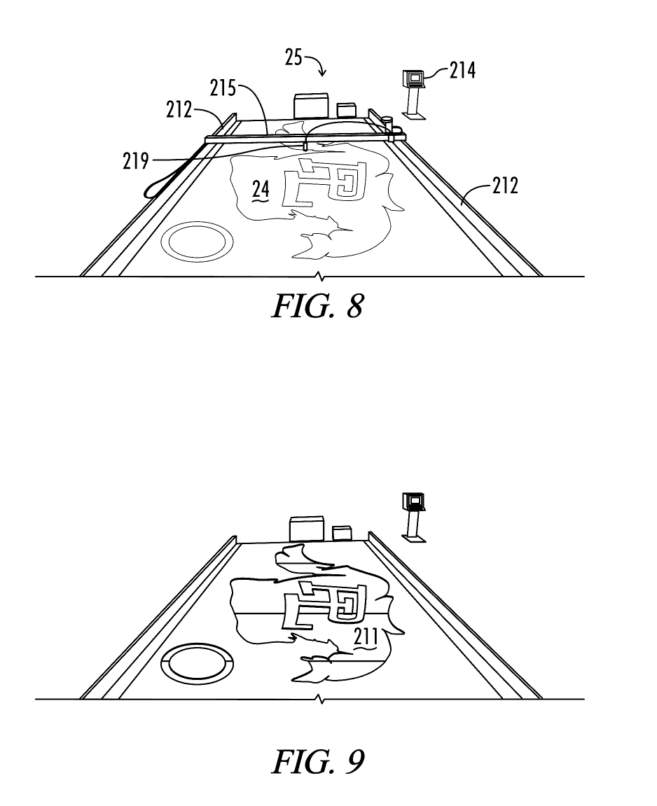

In FIG. 8, the back surface 24 of a strip of artificial turf is visible between the side rails 212 of a water jet cutting system 25. The cross arm 215 moves the cutting water jet head 219 laterally in the illustrated configuration while the cross arm 215 can be moved up and down to provide complete freedom of position over the back 24 of artificial turf. The controller 214 is utilized to cut desired shapes to form inlay segments from the artificial turf. In FIG. 9, it can be seen that many inlay segments have been removed from the artificial turf disclosing the bed 211 upon which the turf was resting.

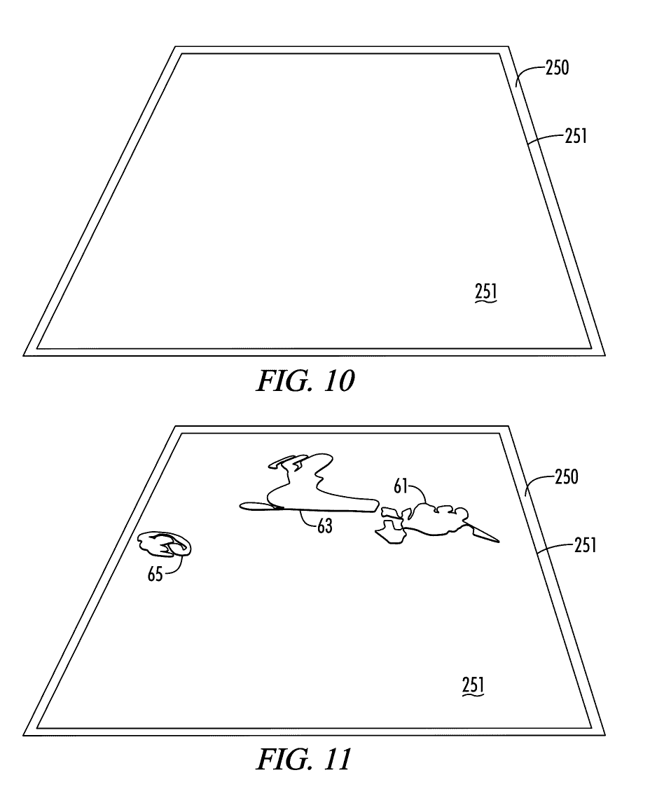

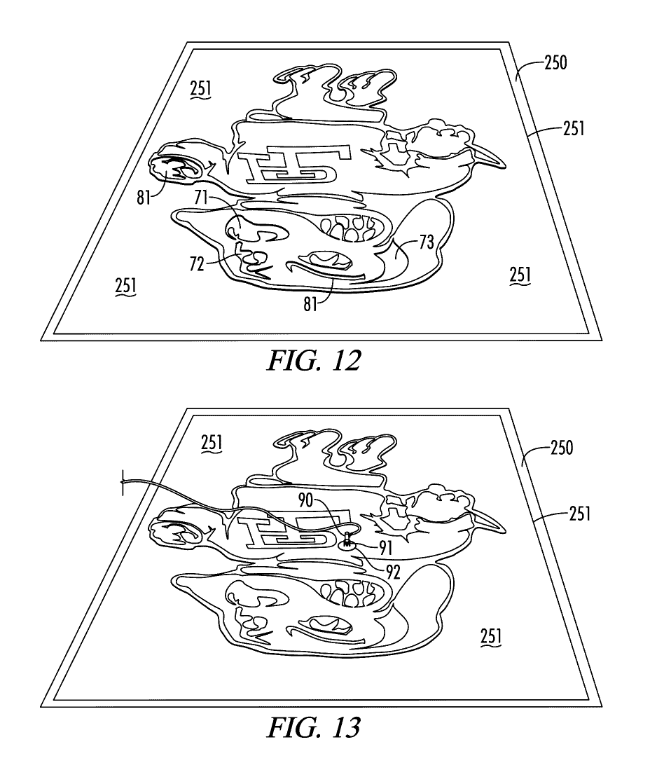

FIG. 10 is an illustration of a work area for the assembly of an inlay in the form of a planar work surface 250 covered with plastic sheeting 251. In FIG. 11, inlay segments 61,65,63 have been positioned on plastic sheeting 51. These inlay segments 61,65,63 are of a first color. In FIG. 12, additional inlay segments 71,72,73 are of a second color and other inlay segments 81 are of yet another color. The inlay segments are positioned on the plastic sheeting 251 with their backing side facing upward and the surface of the artificial turf facing downward onto the plastic sheeting.

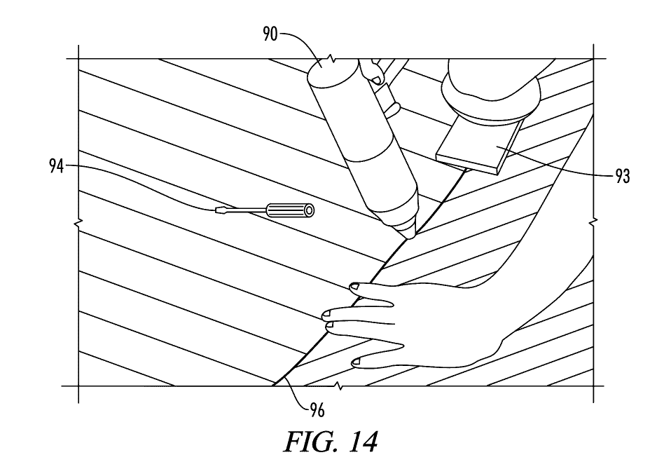

After inlay segments are positioned, there is a step of initially joining the segments together as shown in FIG. 13. Workers position themselves adjacent to the edges of inlay pieces that are to be joined together with hot melt guns 90, hot melt gun rests 91 and support pads 92 for those tools. In addition, workers will utilize pressure boards 93 and hand tools 94 as shown in FIG. 14 to create joining seams utilizing hot melt adhesive. Typical polyurethane reactive hot melt adhesives used are Versatac, 1946, 400S and 900S, having viscosity of about 8000 cps. The worker positions the edges of adjacent inlay pieces in immediate proximity and applies the hot melt gun 90 to dispense flowable hot melt adhesive along seams 96. Once a segment of a joining seam has been formed and set, the cooling blocks 93 are moved over the seam and weight is applied which cools and sets the seam and the worker positions an additional portion of inlay segment edges and applies hot melt adhesive to another segment of the seam. After all of the seams 96 have been formed, the inlay 100 is in one piece. However, the hot melt adhesive is inadequate to hold the inlay segments securely so additional securing is required.

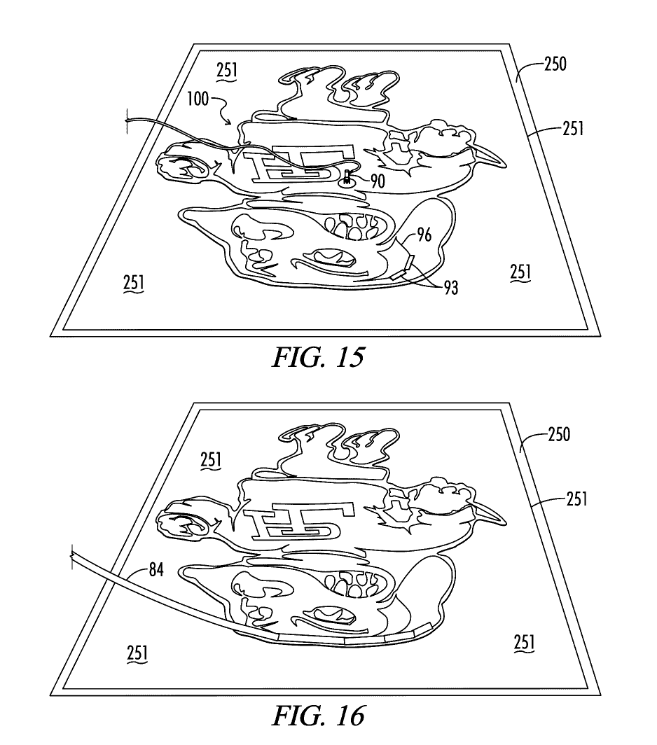

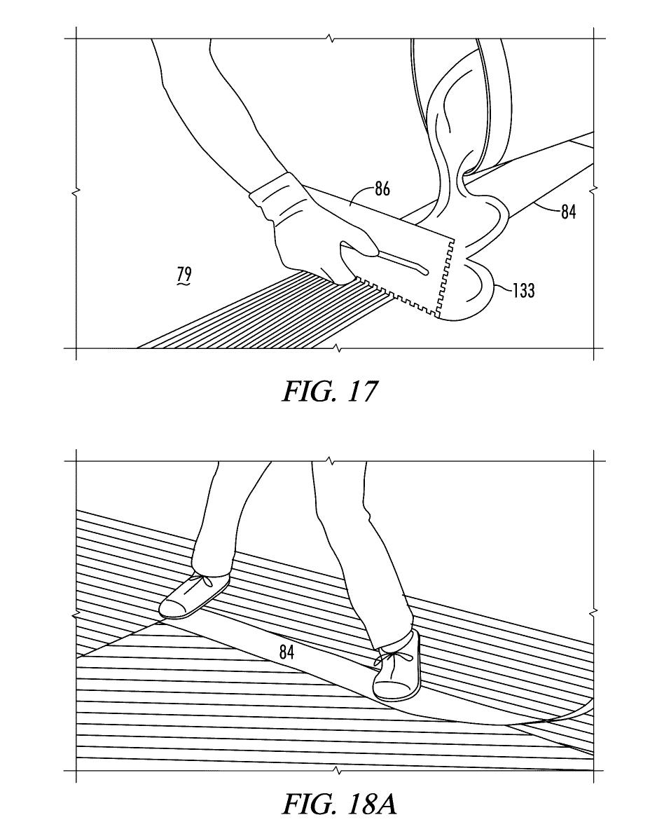

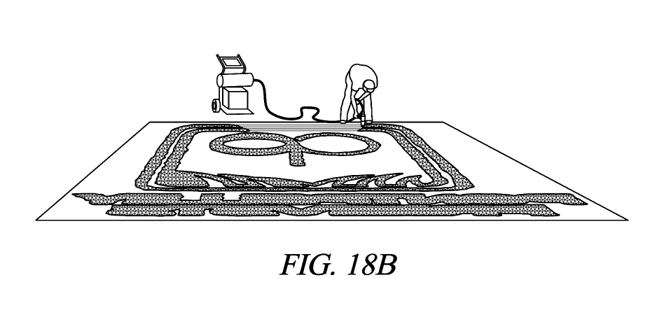

In FIG. 16, a substrate 84 coated with polyurethane adhesive on its downward facing side is being applied along the seams 96 shown in FIG. 15. As shown in FIG. 17, the substrate 84 is laid out on a work surface 79 and a mixed polyurethane adhesive 133 is poured on the substrate and spread with a doctor blade 86 to a relatively uniform coating. Then the substrate 84 is placed with the polyurethane adhesive face down on the seams 96 of the inlay and pressed into the carpet backing along the seams as shown in FIG. 18A. In lieu of manually preparing adhesive coated strips, polyurethane reactive hot-melt, referred to as “blue glue” (HMPUR12-2010 BLUE), HMPUR12-3000 and HMPUR12-3000 SUMMER) may be employed. The blue glue is sprayed directly on the hot melt seams as shown in FIG. 18B by a glue machine that heats and dispenses at relatively low pressure, a width of glue adequate to cover the seams without manual spreading or application of substrates.

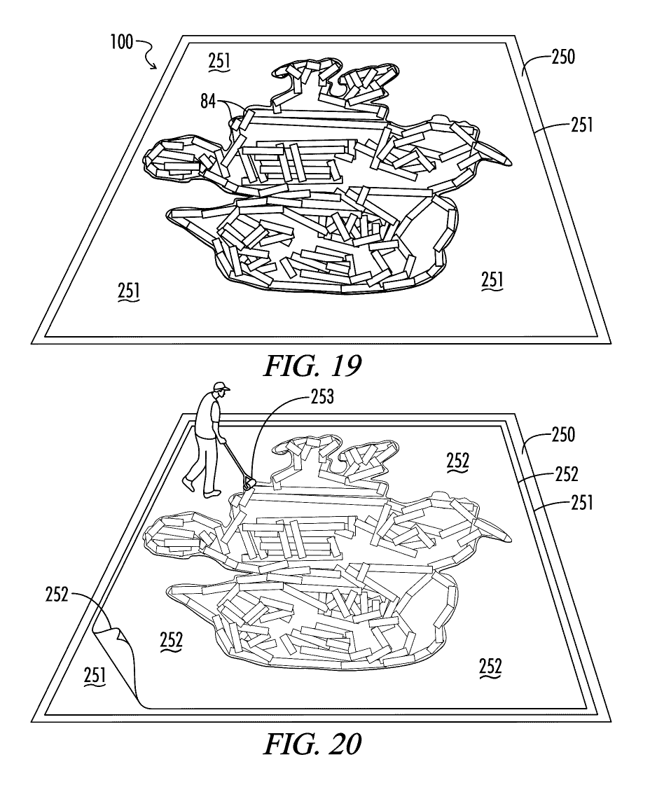

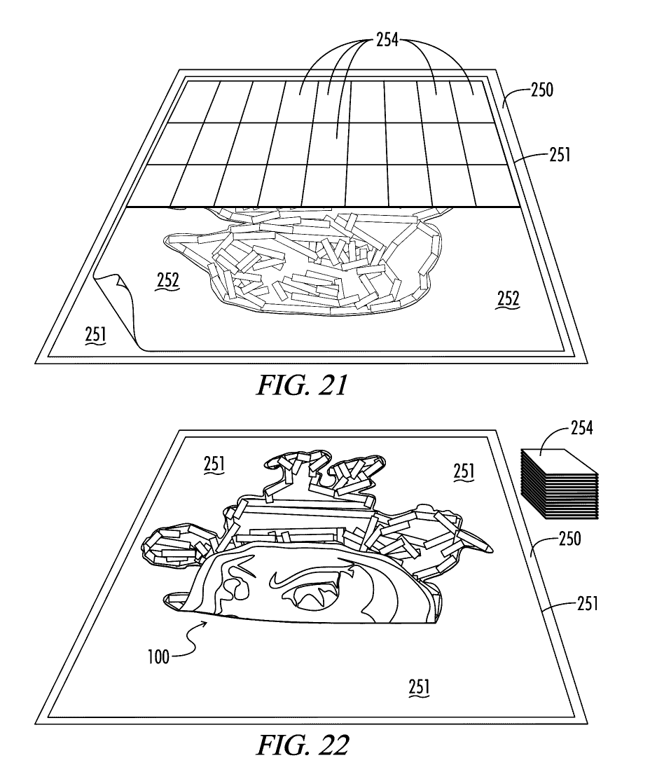

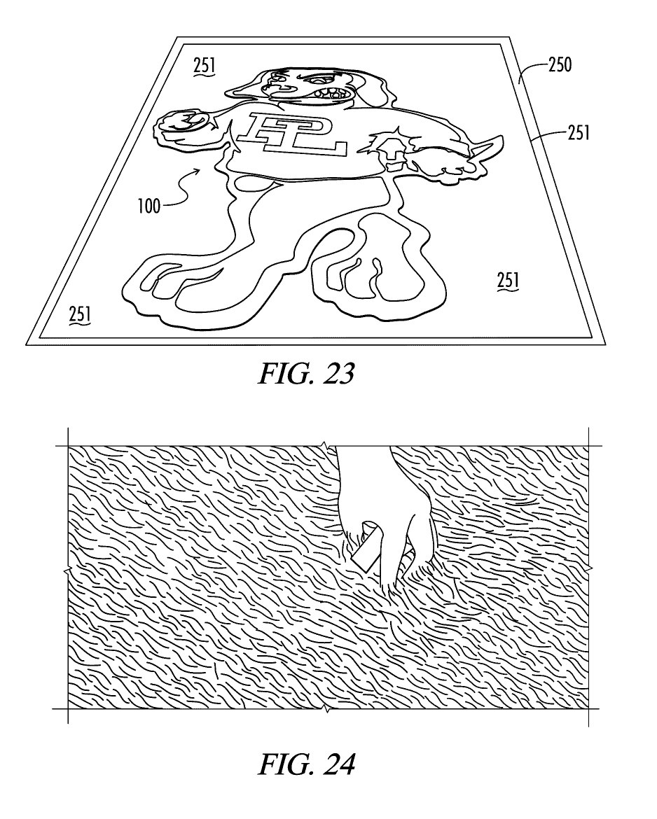

Eventually, all of the seams 96 of the inlay 100 are covered with the polyurethane adhesive coated substrate strips 84 as shown in FIG. 19 and then a top plastic sheeting 252 is placed over the inlay and the inlay is smoothed with rollers 253 as shown in FIG. 20. When this process is completed, plywood boards 254 are placed on top of the inlay overnight, and preferably for about twenty-four hours, so that the polyurethane adhesive can cure as shown in FIG. 21. Once the curing is relatively complete, the plywood 254 is removed and the top plastic sheet 252 is removed and the inlay can then be manipulated as shown in FIG. 22. When the inlay is placed with the face side up, the graphic appearance of the inlay is obvious as shown in FIG. 23 and the final finishing to ensure uniformity of seams and fibers adjacent to the seams takes place as shown in FIG. 24.

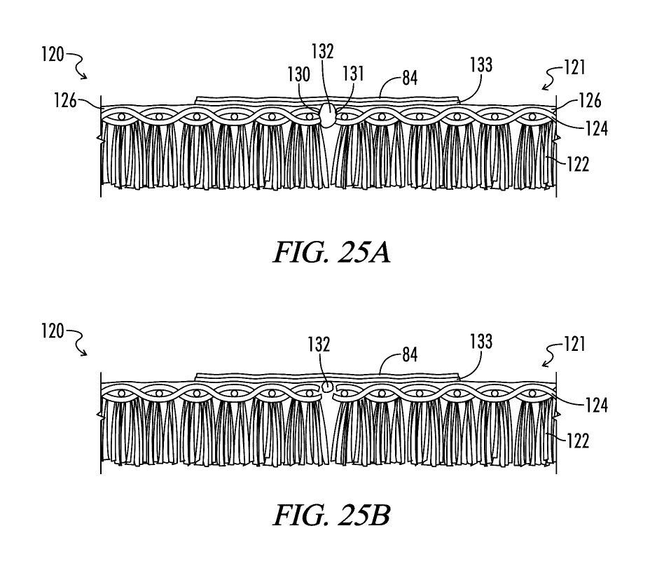

Referring now to FIGS. 25A and 25B, the prior art joinder of two inlay segments 120,121 is shown. Inlay segments 120,121 each include upstanding filament material 122 resembling or simulating blades of grass extending upwards (or downward when positioned for inlay joinder) from a woven backing 124. After the filament material 122 has been tufted in the backing 124, a secondary backing 126 is applied. This backing may be a single layer of resin such as urethane or latex, and it may also include a cushion layer.

The first inlay segment 120 has a first edge 130 and the second inlay segment 121 has a second edge 131 and the edges 130,131 are seamed in close proximity to one another by the placement of a bead of hot melt adhesive 132, such as Versatac, a polypropylene based hot melt system. Over the hot melt is placed the substrate 84 with the doctored layer of polyurethane adhesive 133. Over time the hot melt adhesive 132 deteriorates as shown in FIG. 25B. Segments of the hot melt adhesive may become brittle and break away entirely or simply crack and leave only fragments of the hot melt bead 132 in place. This causes the edges 130,131 to be at least partially exposed to contact upon the surface of the artificial turf and also permits moisture to enter the artificial turf along the seam and attack the adhesion between the polyurethane and the secondary backing 126.

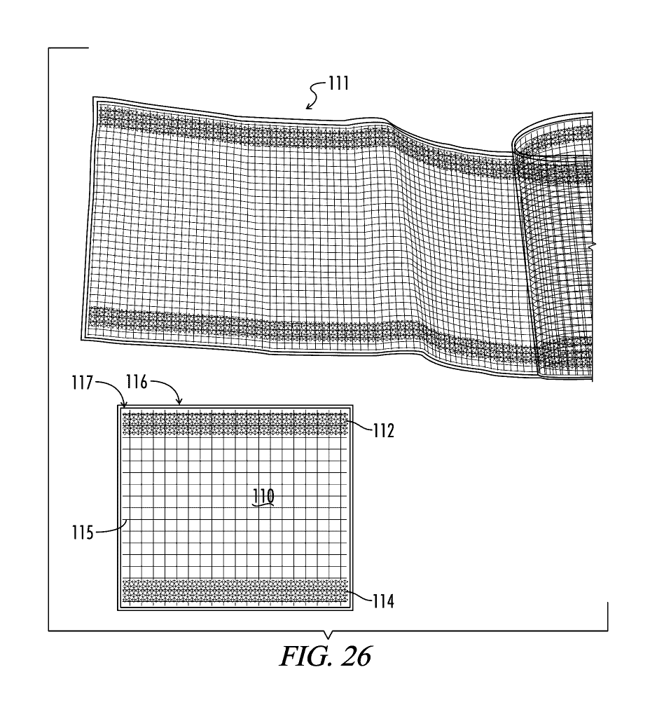

To address this concern, the use of a hot melt bead 132 can be avoided. In FIG. 26, illustrated, a scrim mesh segment 110 and a scrim mesh roll 111 are disclosed. In each case, there is a mesh material, typically of a fiberglass textile, in a plain weave with weft and warp oriented strands of filaments, and with the mesh openings providing direct access to at least 50% of the backing surface upon which it is applied due to the size of the mesh grid relative to the fiberglass textile filaments. An exemplary fiberglass textile would be composed principally of fiberglass filaments, polyester filaments, and polymeric coatings and adhesives. A typical mesh will have strands about 1/30^{th} to 1/40^{th} inch in diameter and a pick count of 4 to 8 strands per inch in both the vertical and horizontal directions. Such a textile provides direct access to about 66% to 90% of the backing covered by the scrim.

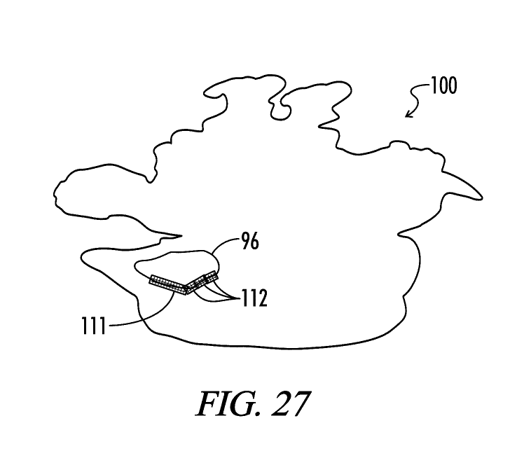

Along each longitudinal edge of the mesh grid 115, is pressure sensitive adhesive 112,114. Each longitudinal line of pressure sensitive adhesive may be about one-half inch in width and one-eighth inch in thickness. After application to the backing, peel away tack strength according to the PTSC procedure are preferably in excess of 30 oz./inch or loop tack strength in excess of about 2.5 lb/in². A peel-away front sheet 117 and back sheet 116 is applied to protect the pressure sensitive adhesive from engaging contact before use. In use, the front sheet 117 of a segment of the mesh scrim 110,111 is removed and the scrim applied along a seam line 96 of the inlay 100 as shown in FIG. 27. The scrim mesh rolls 111 can be cut to length for longer seam segments while the scrim mesh segments 110 can be applied rapidly without cutting and are particularly useful along curved seams 96. Once the mesh scrim is applied, the backing sheets 116 may all be removed. Front sheets 117 and backing sheets 116 may be colored or imprinted with directions for clarity of use, particularly if the pressure sensitive adhesive is oriented for best adhesion in one direction. Once the mesh scrim is completely in place and backing sheets removed, a two part curing polyurethane system such as UL4500A and UL4500B is mixed and applied using an applicator such as a Graco XP70. Alternatively, a two-part polyurea system may be used, typically with shorter gel and curing times, such as VERSAFLEX low pressure products, with a curing time of ten to twenty minutes. The application may be performed directly on the scrim and focused in between the pressure sensitive adhesive sections, though no serious degradation to overall seam strength occurs by covering the pressure sensitive adhesive. The depth of application is between about 0.05 to 0.25 inches, and preferably about 0.1 inches.

Because the scrim mesh is generally between about 3-10 inches in width, there is usually over 2 inches of polyurethane or polyurea and scrim on either side of the seam line interior of the line of pressure sensitive adhesive. Accordingly, even if the pressure sensitive adhesive should degrade, an adequate bond exists between the polyurethane or polyurea and mesh scrim and secondary backing. Furthermore, the polyurethane or polyurea is mixed to an appropriate viscosity and applied so that it will flow into the seam gap between the first edge 130 and second edge 131 much as the hot melt bead does in the initial bonding of the present seaming process. The depth of application of the polyurethane or polyurea is preferably sufficient to cover the scrim so that it is encapsulated or nearly encapsulated and thereby provides the additional stability of the fiberglass textile to the seam.

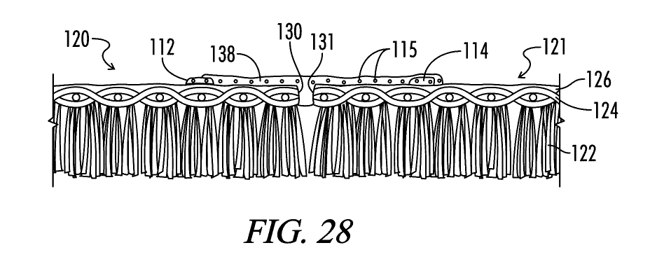

In FIG. 28, the first inlay segment 120 and second inlay segment 121 are illustrated with the scrim 110 applied where the fiberglass textile mesh 115 can be seen in the sectional view encased in a pressure sensitive adhesive 112,114 and polyurethane 138. Polyurethane has flowed in the gap between edges 130 and 131 and has bonded to the secondary backing 126. In this fashion, even if the pressure sensitive adhesive 112,114 degrades, there is no weakening of the seam between edges 130 and 131.

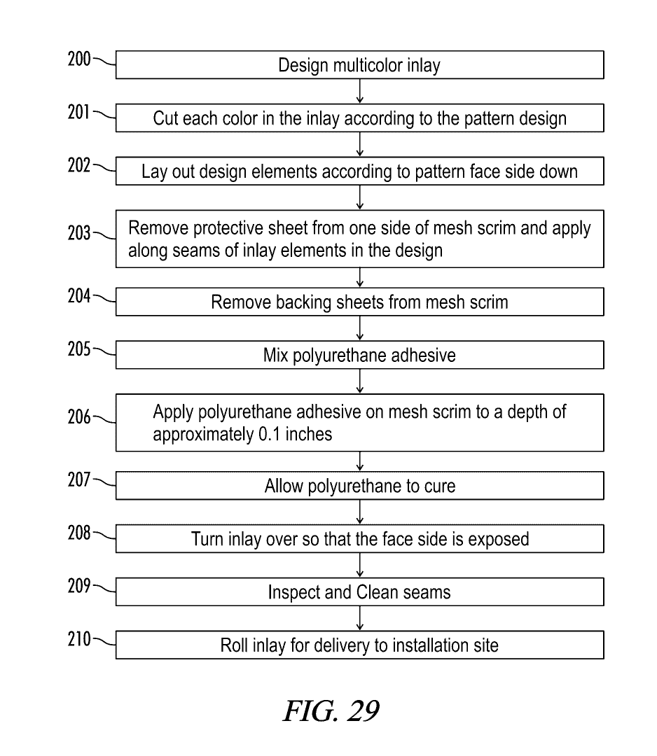

FIG. 29 illustrates the steps involved in the fabrication of an inlay according to an embodiment of the invention.

Numerous alterations of the structure and techniques herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

I claim:

1. A method for joining first and second sections of artificial turf, each having a top surface with upstanding filament material and an opposite bottom surface, utilizing a two-part polyurethane adhesive comprising the steps of:
(a) placing a first edge of the first section of artificial turf in close proximity to a first edge of the second section of artificial turf thereby defining a desired seam location;
(b) positioning a substrate so that it extends across the desired seam location and the first edges of the first and second sections of artificial turf;
(c) preparing a two-part polyurethane adhesive;
(d) applying the polyurethane adhesive to the substrate and the bottom surface of the first and second sections of artificial turf adjacent their first edges; and
(e) allowing the polyurethane adhesive to cure.

2. The method of claim 1 wherein the hardness rating of the cured polyurethane adhesive is less than 70 durometer.

3. The method of claim 1 wherein the polyurethane adhesive substantially cures in less than 60 minutes;

4. The method of claim 1 wherein the grab tear strength of the seam joining the first and second sections of artificial turf is over 300 pounds.

5. The method of claim 1 wherein the first and second sections of artificial turf are placed with top surfaces upward for joining;

6. The method of claim 5 wherein the substrate is laid on a mounting surface beneath the desired seam location between the first and second sections of artificial turf prior to the application of the polyurethane adhesive;

7. The method of claim 6 wherein the substrate is adhered to the mounting surface.

8. The method of claim 1 wherein the polyurethane adhesive is applied with a high pressure spray gun at over 3000 psi.

9. The method of claim 1 wherein the first and second sections of artificial turf are placed with top surfaces facing downward for joining

10. The method of claim 9 wherein the substrate is an adhesive mesh with intersecting strands defining open cells there between, affixed to the bottom surface of the first and second sections of artificial turf adjacent their first edges prior to the application of the polyurethane adhesive.

11. The method of claim 10 wherein an adhesive on the adhesive mesh is a pressure sensitive adhesive with a peel away tack strength of at least 30 ounces per inch.

12. The method of claim 10 wherein the adhesive mesh is a fiberglass textile.

13. The method of claim 10 wherein the adhesive mesh has longitudinal and lateral strands less than 1/25^{th} inch in width.

14. The method of claim 10 wherein the adhesive mesh has longitudinal and lateral strands with a pick count of between four and eight picks per inch.

15. The method of claim 10 wherein the area of the open cells in the adhesive mesh comprises at least about 65% of the surface area of the adhesive mesh.

16. An inlay comprising a first artificial turf segment having a first curved edge contour and a second artificial turf segment having a second curved edge contour that matches the first edge contour and is positioned proximate thereto, each artificial turf segment having a top surface with upstanding filament material and an opposite bottom surface, an open mesh scrim having a pressure sensitive adhesive along its left edge attaching the scrim to the bottom surface of the first artificial turf segment and a pressure sensitive adhesive along its right edge attaching the scrim to the bottom surface of the second artificial turf segment, an adhesive substantially comprising either polyurethane or polyurea encasing a central portion of the scrim between the pressure sensitive adhesive on the right and left edges and filling interstices between the first and second edge contours.

17. The inlay of claim 16 wherein the scrim has a width of between about 3 to 10 inches and is woven with weft and warp oriented strands with between about 4 and 8 picks per inch.

18. The inlay of claim 16 wherein the scrim is a fiberglass textile.

19. The inlay of claim 16 wherein the polyurethane or polyurea encasing a central portion of the scrim has a thickness of less than 0.25 inches.

20. The inlay of claim 16 wherein the polyurethane or polyurea encasing a central portion of the scrim has a hardness of less than 70 durometer.
